(19) United States
(12) Patent Application Publication
(10) Pub. No.: US 2010/0211729 A1
(43) Pub. Date: Aug. 19, 2010

(54) METHOD AND APPARATUS FOR READING AND WRITING DATA

(76) Inventors: Dian Wang, Shenzhen (CN); Guicheng Fan, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/772,281

(22) Filed: May 3, 2010

Related U.S. Application Data
(63) Continuation of application No. PCT/CN2009/072788, filed on Jul. 16, 2009.

(30) Foreign Application Priority Data
Jul. 28, 2008 (CN) 200810135029.5

(51) Int. Cl. G06F 12/00

(52) U.S. Cl. 711/105; 711/151; 711/E12.001

(57) ABSTRACT

A method and an apparatus for reading and writing data are disclosed. The method includes: storing a request in a bank queue; comparing weight values of different banks in the bank queue, wherein the different banks comply with a time sequence parameter; and scheduling the bank queue according to the comparison result. With the embodiments of the present invention, the operation sequence may be optimized, and the buffer efficiency may be greatly improved.

### CROSS-REFERENCE TO RELATED APPLICATIONS

This application is a continuation of International Application No. PCT/CN2009/072788, filed on Jul. 16, 2009, which claims priority to Chinese Patent Application No. 200810135029.5, filed on Jul. 28, 2008, both of which are hereby incorporated by reference in their entireties.

### FIELD OF THE INVENTION

The present invention relates to the network communication field, and in particular, to a method and apparatus for writing and reading data.

### BACKGROUND OF THE INVENTION

In data networks, a dynamic random access memory (DRAM) chip is generally used as the data buffer space. This kind of chip has the following features: A chip is divided into multiple banks and each bank is divided into a lot of rows. Before a row is read or written, the row must be activated. Different rows of a bank cannot be opened at the same time. Thus, when a row of a bank is already activated, the activated row must be deactivated before another row to be operated is activated; then another row is read or written. A row must be activated or deactivated after a minimum time. If the minimum time does not expire, other rows of the bank cannot be operated, which is briefly called a bank conflict.

With the increase of the chip frequency, the waiting time is longer and longer relative to the clock frequency and the efficiency is lower and lower. For example, when the DDR2 chip is read, the interval between two successive operations of reading different rows of the same bank is 55 ns (tRAS+tRP) if the clock frequency is 200 MHz, which is equivalent to 11 clock periods. When the clock frequency is 400 MHz, the interval is 60 ns, which is equivalent to 24 clock periods. In the prior art, a lot of optimization methods are provided to overcome the long waiting time when different rows of the same bank are accessed continuously. For example, multiple banks are read or written in sequence to reduce and even avoid the bank conflict. However, this method improves the efficiency at the cost of space, wasting the buffer space. In addition, repeated data is written to multiple banks, which wastes the buffer bandwidth. Further, this method strictly specifies the sequence of read or write operation. In network processor applications, the data may not be read in sequence due to the influence of the quality of service (QoS). Thus, this method is only applicable to a specific scenario.

In the prior art, the banks occupied by cells of each address are re-sorted by operating several neighbor cells, and available banks are selected for operations so as to reduce the waiting time. In this method, however, only cells complying with the operation time requirement can be searched in sequence, and the overall operation cannot be optimized. As shown in FIG. 1, a request for reading four cells is received in a time segment, where cell_{—}0 to cell_{—}2 occupy two banks respectively and cell_{—}3 occupies eight banks. According to the prior art, the operation sequence is as follows: ccell_{—}0 bank0→cell_{—}0 bank1→cell_{—}3 bank2→ . . . →cell_{—}3 bank7→cell_{—}1 bank0→cell_{—}1 bank1→waiting→cell_{—}2 bank0→ . . . . That is, as shown in FIG. 2, after cell_{—}3 bank7 is operated, only two banks of cell_{—}1 to cell_{—}3 are left, which brings about a bank conflict and a waste of bandwidth resources.

The method in the prior art strictly specifies the sequence of reading or writing a bank and wastes the storage space when the method is adopted to solve the problem of the interval required when different rows of the same bank are accessed. In addition, this method can only optimize the read or write operations partially.

### SUMMARY OF THE INVENTION

Embodiments of the present invention provide a method and apparatus for reading and writing data to improve the buffer efficiency and optimize the operation sequence as a whole.

A method for writing and reading data includes:
storing a request in a bank queue according to a preset capacity value of a bank;
comparing weight values of different banks in the bank queue, wherein the different banks comply with a time sequence parameter; and
scheduling the bank queue according to the comparison result.

An apparatus for writing and reading data includes:
a bank slicing module, configured to store a request in a bank queue according to the preset capacity value of a bank;
a weight comparing module, configured to calculate and compare weight values of each bank in the bank queue, wherein the different banks comply with a time sequence parameter; and
a scheduling module, configured to schedule the bank queue according to the comparison result of the weight comparing module.

Compared with the prior art, embodiments of the present invention have the following merits:

The request is stored in the bank queue according to the preset capacity value of the bank, and the bank queue is scheduled according to the weight value of the bank queue. Thus, the buffer efficiency can be greatly improved, and the operation sequence can be optimized as a whole.

### BRIEF DESCRIPTION OF THE DRAWINGS

To make the technical solution under the present invention or in the prior art clearer, the accompanying drawings for illustrating the embodiments of the present invention or illustrating the prior art are outlined below. Evidently, the accompanying drawings are exemplary only, and those skilled in the art can derive other drawings from such accompanying drawings without creative work.

FIG. 1 is a schematic diagram illustrating the distribution of read or write operations in the prior art;

FIG. 2 is a schematic diagram illustrating the distribution of read or write operations in the prior art;

FIG. 3 is a flowchart of a method for reading and writing data in an embodiment of the present invention;

FIG. 4 is a flowchart of a method for reading and writing data in another embodiment of the present invention; and

FIG. 5 is a flowchart of an apparatus for reading and writing data in an embodiment of the present invention.

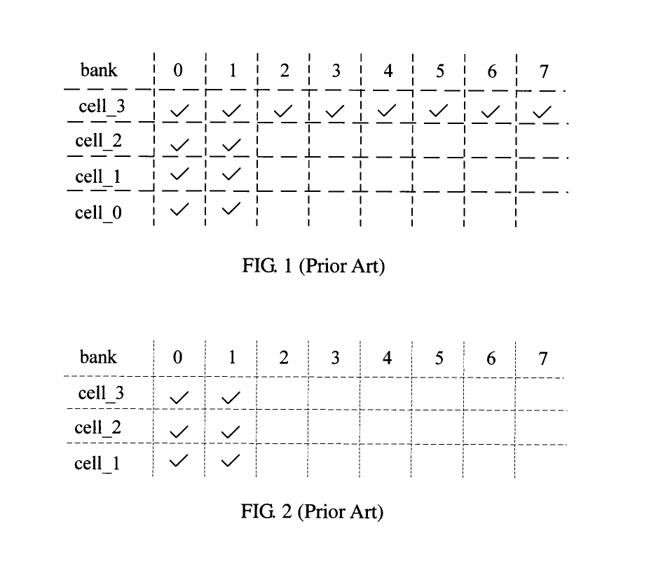

### DETAILED DESCRIPTION OF THE EMBODIMENTS

The technical solution of the present invention is hereinafter described in detail with reference to the accompanying drawings. It is evident that the embodiments are only exemplary embodiments of the present invention and the present invention is not limited to such embodiments. Those skilled in the art can derive other embodiments from the embodiments given herein without creative work, and all such embodiments are covered in the scope of protection of the present invention.

Embodiments of the present invention provide a method and apparatus for reading and writing data to improve the buffer efficiency and optimize the operation sequence as a whole.

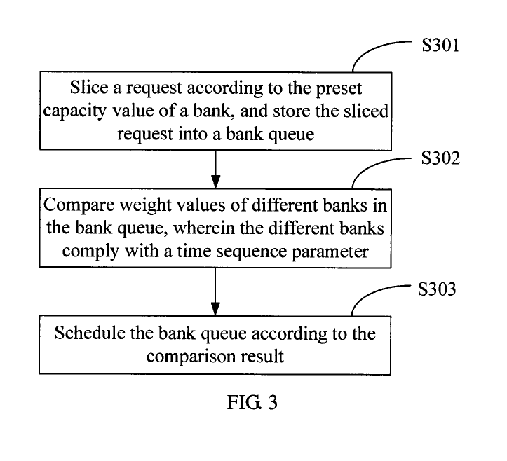

FIG. 3 is a flowchart of a method for writing and reading data in an embodiment of the present invention. The method includes the following steps:

Step S301: Slice a request according to the preset capacity value of a bank, and store the sliced request in a bank queue.

Specifically, the bank has the same or different preset capacity values in different scenarios. When a read request or write request is received, the data traffic of the read request or write request may be sliced according to the preset capacity value. That is, the read request or write request is stored in multiple banks. These banks form a bank queue, and each bank has a unique ID in the bank queue, where the ID may be used as the basis for scheduling the bank. When only one bank exists in the scenario, the request is directly written to the bank. Certainly, in actual applications, the request may not be sliced, but be directly stored in the bank queue. For example, when the data traffic of the read request or write request is greater than the preset capacity value of the bank, the read request or write request is sliced and stored in multiple banks. If the data traffic of the read request or write request is smaller than the preset capacity value of the bank, the request is directly stored in the bank queue.

Step S302: Compare weight values of different banks in the bank queue, wherein the different banks comply with a time sequence parameter. Specifically, the weight values are generated according to the quantity of requests in the bank. The bank with more requests has a larger weight value. During the scheduling, multiple banks may have the same quantity of requests. In this case, a priority and the quantity of requests may be used for generating the weight value. The priority is related to the time when the request is stored in the bank. The priority of a bank that complies with the time sequence parameter but is not scheduled within a preset time is increased. The priority and the quantity of requests are used for generating a weight value, which may avoid the case that a bank is not scheduled for a long time. According to the actual engineering experience, scheduling the bank according to the weight value may avoid bank conflicts effectively and improve the scheduling efficiency.

Step S303: Schedule the bank queue according to the comparison result.

When the banks comply with the time sequence parameter, the banks with a larger weight value are scheduled first. When the weight values of the banks are equal, any bank is scheduled. When any bank is scheduled, the banks may be scheduled according to the IDs (for example, sequence numbers) of the banks. For example, the banks may be scheduled according to the sequence numbers of the banks in ascending order. Certainly, when any bank is scheduled, the banks may be scheduled according to other user-defined rules.

In the method for reading and writing data in the preceding embodiment, the request is sliced and stored in the bank queue, and the banks are scheduled according to the weight values of the banks. Thus, the buffer efficiency can be greatly improved and the operation sequence can be optimized as a whole.

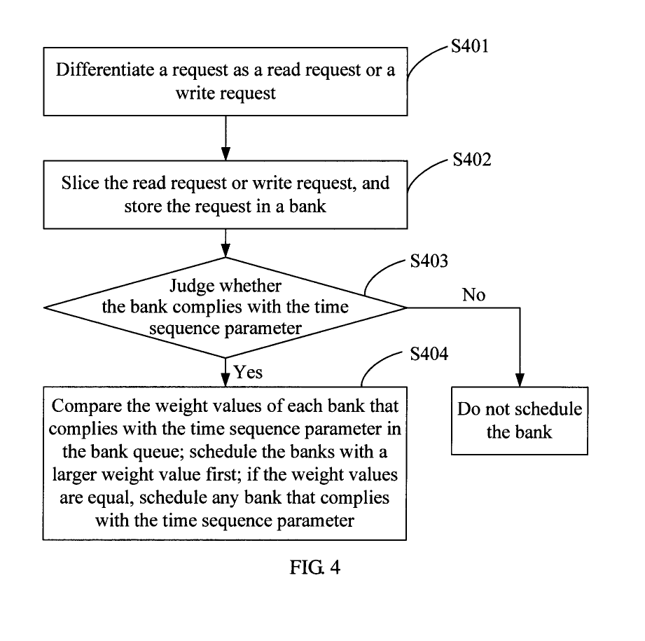

In a method for reading and writing data in another embodiment of the present invention, a read or write request may be differentiated as a read request or a write request, and sliced according to the preset capacity value of a bank. The read request or write request is stored in different banks for scheduling. Thus, the read or write operations may be optimized as a whole. As shown in FIG. 4, the specific implementation process includes the following steps:

Step S401: Differentiate a request as a read request or a write request. Specifically, after a read or write request is received, the request is determined as a read request or a write request according to the ID information in the request.

Step S402: Slice the read request or write request, and store the request in a bank.

Specifically, the bank has the same or different preset capacity values in different scenarios. When the data traffic of the read request or write request is greater than the preset capacity value of the bank, the read request or write request is stored in multiple banks. Multiple banks form a bank queue, and each bank has a unique ID in the bank queue. The read request or write request is stored in different banks for scheduling.

Step S403: Judge whether each bank in the bank queue complies with the time sequence parameter. Complying with the time sequence parameter means that the line feed operation on the bank is performed at the interval of a time sequence parameter after the previous read or write operation is completed. The banks that do not comply with the time sequence parameter are not scheduled. For the banks that comply with the time sequence parameter, the process proceeds to step S404.

Step S404: Compare the weight values of the banks in the bank queue that complies with the time sequence parameter.

Specifically, the weight values of each bank in the bank queue are obtained and compared. The banks with a larger weight value are scheduled first. If the weight values are equal, any bank that complies with the time sequence parameter is scheduled. The weight values may be generated according to the quantity of requests in the bank. The bank with more requests has a larger weight value. The weight value may also be generated according to the priority of the bank and the quantity of requests in the bank. The banks with a higher priority have larger weight values. The banks of the same priority with more requests have larger weight values. The priority is related to the time when the request is stored in the bank. The priority of a bank that complies with the time sequence parameter but is not scheduled within a preset time is increased. The priority and the quantity of requests are used for generating a weight value, which may avoid the case that a bank is not scheduled for a long time.

When the weights values of each bank in the bank queue are equal, any bank that complies with the time sequence parameter is scheduled. At this time, the banks may be scheduled according to the sequence numbers of the banks in ascending order. Certainly, in actual applications, the scheduling sequence is not limited to the preceding sequence. The banks may also be scheduled according to the sequence numbers in descending order or in other user-defined order. Taking FIG. 1 as an example, during the first scheduling, bank0 and bank1 have four requests respectively, with the same weight value. Because the sequence number of bank0 is smaller, bank0 is scheduled; during the second scheduling, bank1 has four requests, with the largest weight value, and thus is scheduled; during the third scheduling, bank0 and bank1 with larger weight values do not comply with the time sequence parameter, and cannot be scheduled; among the banks with the same weight value, bank2 has the smallest sequence number, and is scheduled first; during the fourth scheduling, bank0, bank1, and bank2 do not comply with the time sequence parameter; among the banks with the same weight value, bank3 has the smallest sequence number, and is scheduled first; during the fifth scheduling, bank0 with a larger weight value is assumed to comply with the time sequence requirement, and is scheduled first. The rest may be deduced in the same way. The optimal operation sequence is as follows: cell_{—}0 bank0→cell_{—}0 bank1→cell_{—}3 bank2→cell_{—}3 bank3→cell_{—}1 bank0→cell_{—}1 bank1→cell_{—}3 bank4→cell_{—}3 bank5→cell_{—}2 bank0→cell_{—}2 bank1→cell_{—}3 bank6→cell_{—}3 bank7.

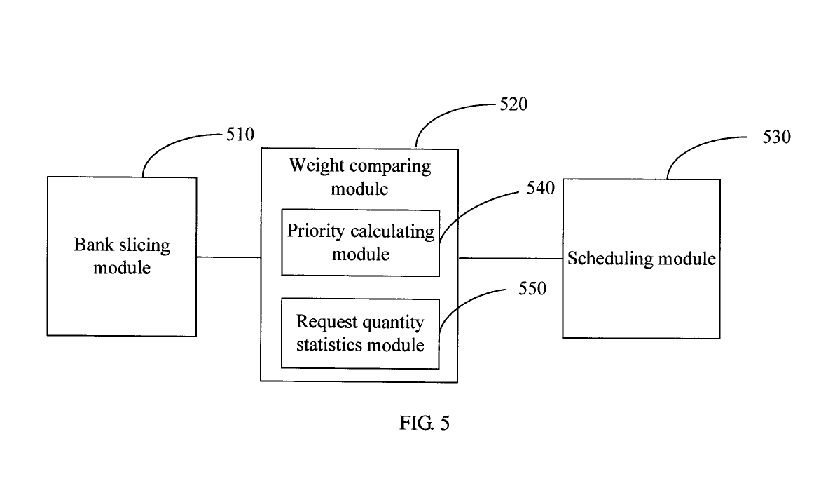

FIG. 5 illustrates an apparatus for writing and reading data in an embodiment of the present invention. The apparatus includes:
a bank slicing module 510, configured to slice a request according to the preset capacity value of a bank;
a weight comparing module 520, configured to calculate and compare weight values of each bank in a bank queue that complies with the time sequence parameter; and
a scheduling module 530, configured to schedule the bank queue according to the comparison result of the weight comparing module.

In actual applications, the bank slicing module 510 may not slice the request. It may determine whether to slice the request according to the data traffic of the request.

Specifically, the bank slicing module 510 is configured to: obtain the data traffic of the request; if the data traffic of the request is greater than the preset capacity value of the bank, slice the request and store the sliced request in the bank queue; if the data traffic of the request is smaller than the preset capacity value of the bank, store the request in the bank queue directly.

The weight comparing module 520 further includes a priority calculating module 540 and a request quantity statistics module 550. The priority calculating module 540 is configured to increase the priority of the bank when a bank that complies with the time sequence parameter is not scheduled. The request quantity statistics module 550 is configured to measure the quantity of requests in each bank in the bank queue. In this embodiment, the weight comparing module 520 calculates the weight value of the bank according to the quantity of requests and/or the priority of each bank. It should be noted that one or both of the priority calculating module 540 and the request quantity statistics module 550 may be selected to calculate the weight value according to the actual need.

More specifically, the weight value may be calculated in accumulation mode. For example, when the quantity of requests of the bank reaches a value, a preset value is added to the weight value, or when the priority of the bank is increased to a value, a same preset value or different preset values may be added to the weight value. Certainly, the preceding weight value calculation method is an example only, and does not limit the scope of protection of the present invention.

In a specific application, the apparatus for reading and writing data is located in a storage device, where the storage device may be a DRAM chip.

By using the method and apparatus provided in embodiments of the present invention, the request is sliced according to the preset capacity value of the bank; the sliced request is stored in the bank queue; the bank queue is scheduled by comparing the weight values of the banks. Thus, the buffer efficiency can be greatly improved, and the operation sequence can be optimized as a whole.

Through the descriptions of the preceding embodiments, those skilled in the art may understand that the present invention may be implemented by hardware only or by software and a necessary universal hardware platform. Based on such understandings, the technical solution under the present invention may be embodied in the form of a software product. The software product may be stored in a nonvolatile storage medium, which can be a compact disk read-only memory (CD-ROM), a USB disk, or a removable hard disk. The software product includes a number of instructions that enable a computer device (personal computer, server, or network device) to execute the methods provided in the embodiments of the present invention.

The above descriptions are merely some exemplary embodiments of the present invention, but not intended to limit the scope of the present invention. Any modifications or variations that can be derived by those skilled in the art should fall within the scope of the present invention.

What is claimed is:

1. A method for reading and writing data, comprising:
storing a request in a bank queue;
comparing weight values of different banks in the bank queue, wherein the different banks comply with a time sequence parameter; and
scheduling the bank queue according to the comparison result.

2. The method of claim 1, wherein storing the request in the bank queue comprises:
acquiring data traffic of the request;
if the data traffic of the request is greater than a preset capacity value of the bank, slicing the request, and storing the sliced request in the bank queue; and
if the data traffic of the request is smaller than the preset capacity value of the bank, storing the request in the bank queue directly.

3. The method of claim 1, further comprising:
differentiating the request as a write request or a read request according to an ID in the request.

4. The method of claim 1, wherein scheduling the bank queue according to the comparison result comprises:
scheduling a bank with a largest weight value first if the bank complies with the time sequence parameter.

5. The method of claim 1, wherein the weight values comprise:
a weight value generated according to the quantity of requests stored in a bank.

6. The method of claim 5, wherein a weight value of a bank with more requests is larger than a weight value of a bank with fewer requests.

7. The method of claim 6, wherein if multiple banks have a same quantity of requests, the weight values of the multiple banks are generated according to priorities of the multiple banks.

8. The method of claim 7, wherein if a bank in the multiple banks complies with the time sequence parameter and is not scheduled within a preset time, a priority of the bank is increased.

9. The method of claim 1, wherein the weight values comprise:
a weight value generated according to a priority of a bank.

10. The method of claim 9, wherein if the bank complies with the time sequence parameter and is not scheduled within a preset time, a priority of the bank is increased.

11. A computer-readable storage medium, comprising computer program codes which when executed by a computer processor cause the compute processor to execute steps of:
storing a request in a bank queue;
comparing weight values of different banks in the bank queue, wherein the different banks comply with a time sequence parameter; and
scheduling the bank queue according to the comparison result.

12. An apparatus for reading and writing data, comprising:
a bank slicing module, configured to store a request in a bank queue;
a weight comparing module, configured to calculate and compare weight values of different banks in the bank queue, wherein the different banks comply with a time sequence parameter; and
a scheduling module, configured to schedule the bank queue according to the comparison result of the weight comparing module.

13. The apparatus of claim 12, wherein the bank slicing module is configured to: acquire data traffic of the request; if the data traffic of the request is greater than the preset capacity value of the bank, slice the request and store the sliced request in the bank queue; if the data traffic of the request is smaller than the preset capacity value of the bank, store the request in the bank queue directly.

14. The apparatus of claim 12, wherein the weight comparing module comprises a request quantity statistics module configured to measure a quantity of requests of a bank in the bank queue and the weight comparing module calculates a weight value according to the quantity of requests.

15. The apparatus of claim 12, wherein the weight comparing module further comprises a priority calculating module configured to calculate a priority of a bank in the bank queue and the weight comparing module calculates a weight value according to the priority of the bank in the bank queue.

16. The apparatus of claim 15, wherein when a bank complying with the time sequence parameter is not scheduled, the priority calculating module increases a priority of the bank that is not scheduled.
